(19) United States
(12) Patent Application Publication
(10) Pub. No.: US 2004/0040847 A1
(43) Pub. Date: Mar. 4, 2004

(54) Gas sensor element and method of manufacturing same

(75) Inventor: Kazunori Suzuki, Nagoya (JP)

Correspondence Address: NIXON & VANDERHYE, PC, 1100 N GLEBE ROAD, 8TH FLOOR, ARLINGTON, VA, 22201-4714, US

(73) Assignee: Denso Corporation, Aichi-pref (JP)

(21) Appl. No.: 10/648,294

(22) Filed: Aug. 27, 2003

(30) Foreign Application Priority Data
Aug. 28, 2002 (JP) 2002-249367
Aug. 29, 2002 (JP) 2002-251435

(51) Int. Cl. G01N 27/26

(52) U.S. Cl. 204/426; 204/424; 29/592.1

(57) ABSTRACT

A gas sensor element comprises a solid electrolytic sheet provided with a pair of electrodes so as to constitute an electrochemical cell, at least one another sheet disposed so as to oppose to the solid electrolytic sheet, a spacer disposed between these sheets so as to define a gas chamber therebetween in which gas contacts the electrodes, and a support member disposed in the gas chamber so as to support a pressing force applied in a direction of lamination of the solid electrolytic sheet and the other sheet.

### BACKGROUND OF THE INVENTION

The present invention relates to a gas sensor or gas sensor element (herein, called “gas sensor element”) for detecting concentration of a gas such as NOx contained in a gas to be measured and also relates to a method of manufacturing a such gas sensor element.

A gas sensor element is a kind of detector for detecting a gas concentration such as NOx contained in a gas, such as exhaust gas, to be measured by a plurality of electrochemical cells formed by providing a pair of electrodes to a solid electrolytic sheet. More specifically, between the solid electrolytic sheet and another (opposing) sheet disposed so as to oppose thereto, there is arranged a spacer by which a gas measurement chamber, into which a gas to be measured (measurement gas) is introduced, or a reference gas chamber, into which atmosphere as a reference gas for measurement is introduced. After oxygen concentration of the measurement gas introduced into the gas measurement chamber is adjusted or regulated, the concentration of NOx or like contained therein is obtained.

A gas sensor element utilized for the purpose mentioned above is, for instance, shown in FIG. 30.

With reference to FIG. 30, a gas sensor element 9 of a conventional structure comprises a porous sheet 931, a shield sheet 932, a spacer 933, a solid electrolytic sheet 94 constituting a monitor cell 3 and a sensor cell 4, a spacer 95, a solid electrolytic sheet 96 constituting a pump cell 2, a spacer 97, a cover (coat) heater sheet 996 and a heater sheet 995 (both heater sheets may be called merely “heater sheet 99”). These sheets are laminated in a predetermined order as shown in FIG. 30, and this laminated structure is pressed in the laminated direction and then sintered in a state that the respective sheets 931, 932, 94, 96 and 99 (995, 996) and the respective spacers 933, 95, and 97 are laminated in the order.

On the other hand, in the gas sensor element of the structure mentioned above, gas chambers 91, 92, 921 and 922 formed between the adjacent sheets and inside the respective spacers 933, 95 and 97 have hollow structures, and for this reason, when the pressure is applied to the laminated structure, the shield sheet 932 disposed most outside, upper side as viewed, of the gas sensor element 9 may be flexed towards the gas chamber 921. In such case, as shown in FIGS. 31 and 32, crack(s) 901 may be caused along the longitudinal direction of the gas sensor element 9 at a substantially central portion in the width direction of the shield sheet 932. This problem of crack generation may be also caused to the other sheets 931, 94, 96 and 99 in the laminated state.

Incidentally, electrodes 31 and 32 of the monitor cell 3 and electrodes 41 and 42 of the sensor cell 4 are formed by screen-printing a metal paste on a surface of the solid electrolytic sheet 94, and also, electrodes 21 and 22 of the pump cell 2 are formed by screen-printing a metal paste on a surface of the solid electrolytic sheet 96. In addition, a heating element 991 of the heater sheet 99 is also formed through the screen printing process on the surface of the heater sheet 995.

As shown in FIGS. 33 and 34, however, in the gas sensor element 9, the heating element 991 which is subjected to the screen printing has a protruded surface, i.e., circular surface having front end portion 992 as shown in FIG. 34. For this reason, when the laminated structure of the gas sensor element 9 is provided, the protruded front end 992 will abut linearly against the cover heat sheet 996 towards the longitudinal direction L of the gas sensor element 9.

Therefore, when the respective sheets 931, 932, 94, 96, 996, 995 and the respective spacers 933, 95, 97 are laminated and then pressed in the laminated state, crack(s) 901 may be caused at a portion corresponding to the protruded front end forming portion 992.

### SUMMARY OF THE INVENTION

The present invention was conceived to substantially eliminate defects or drawbacks encountered in the prior art mentioned above, and one primary object of the present invention is to provide a gas sensor element having an improved structure capable of effectively prevent cracks from causing to sheets forming the sensor element at a time of manufacturing the gas sensor element.

Another object of the present invention is to provide a method of manufacturing a gas sensor element capable of effectively preventing cracks from causing at a time of the manufacture thereof.

The above and other objects can be achieved according to the present invention by providing, in one aspect, a gas sensor element comprising:

a solid electrolytic sheet provided with a pair of electrodes so as to constitute an electrochemical cell;

another sheet disposed so as to oppose to the solid electrolytic sheet so as to define a gas chamber therebetween in which gas contacts the electrodes;

a spacer disposed in the gas chamber between these sheets; and

a support member disposed in the gas chamber so as to support a pressing force applied in a direction of lamination of the solid electrolytic sheet and the another sheet.

In this aspect, it may be preferred that the gas chamber has a long scale extending along a longitudinal direction thereof and the support member is disposed at a position for supporting substantially a central portion of the gas chamber in a width direction thereof normal to the longitudinal direction thereof.

The support member may have a sectional area taken along the line normal to the longitudinal direction of the gas chamber, the sectional area occupies 5 to 95% of a sectional area of the gas chamber in the longitudinal direction thereof.

In a more specific embodiment, there is provided a gas sensor element comprising:

a shield sheet;

a first solid electrolytic sheet constituting a monitor cell and a sensor cell;

a first spacer disposed between the shield sheet and the first solid electrolytic sheet so as to form a first reference gas chamber therebetween;

a second solid electrolytic sheet constituting a pump cell;

a second spacer disposed between the first and second solid electrolytic sheets so as to form a gas measurement chamber therebetween;

a heater sheet provided with a heating element;

a third spacer disposed between the second solid electrolytic sheet and the heater sheet so as to form a second reference gas chamber, the shield sheet, the first and second solid electrolytic sheets and the heater sheet being laminated in a predetermined order; and

support members disposed respectively in the first and second reference gas chambers and the gas measurement chamber.

There may be also provided a gas sensor element comprising:

a first solid electrolytic sheet constituting a first pump cell;

a second solid electrolytic sheet constituting a second pump cell, a monitor cell and a sensor cell;

a first spacer disposed between the first and second solid electrolytic sheets so as to form a gas measurement chamber therebetween;

a heater sheet provided with a heating element;

a second spacer disposed between the second solid electrolytic sheet and the heater sheet so as to form a reference gas chamber therebetween, the first and second solid electrolytic sheets and the heater sheet being laminated in a predetermined order; and

support members disposed respectively in said reference gas chamber and said gas measurement chamber.

According to the gas sensor element of the structures and characters mentioned above, even if any pressing force is applied, in the lamination direction, to the solid electrolytic sheet and the other sheet opposing to the solid electrolytic sheet, this pressing force can be supported (held) by the support member disposed in the gas measurement chamber formed between the above-mentioned sheets, thus providing a strength to the gas sensor element.

More in detail, in the manufacture of the gas sensor element, the solid electrolytic sheet, the opposing sheet and the spacer disposed therebetween are pressurized in their laminated state. In such case, this pressing force can be supported by the support member disposed in the gas measurement chamber defined between the above-mentioned sheets, thus preventing the bending or flexing of the solid electrolytic sheet and/or the opposing sheet towards the gas measurement chamber and also preventing cracks from causing to the solid electrolytic sheet and the opposing sheet.

After the pressurizing process, a sintering treatment is carried out. In this process, if the opposing sheet and/or the spacer are made of materials different from a material of the solid electrolytic sheet, there is a fear that the solid electrolytic sheet or opposing sheet may be flexed towards the gas measurement chamber due to difference in thermal expansion coefficient of the opposing sheet or spacer and the solid electrolytic sheet. In such case, according to the present invention, the bending or flexing of the solid electrolytic sheet and/or the opposing sheet towards the gas measurement chamber can be prevented, and the generation of cracks to the solid electrolytic sheet and the opposing sheet can be also prevented.

Furthermore, in the embodiments in which a plurality of sheets such as including the shield sheet, first and second solid electrolytic sheets, and the heater sheets are arranged in the laminated state and the spacers disposed between the respective sheets so as to define the gas measurement chamber and the reference gas chamber therebetween, the support members may be disposed in the respective gas chambers so as to prevent the sheets from being flexed or bent and to prevent cracks from causing thereto.

In another aspect of the present invention, there is provided a method of manufacturing a gas sensor element comprising the steps of:

preparing a non-sintered substrate;

forming a conductive layer on a surface of the non-sintered substrate and forming a flat portion on the surface of the conductive layer during the conductive layer forming step so that the flat portion has a width more than 3% of a width of the conductive layer;

laminating a non-sintered lamination sheet on the surface of the conductive layer on the non-sintered substrate so as to provide an intermediate product; and

sintering the thus laminated intermediate product.

According to this method, the flat portion is formed to the protruded front end portion of the conductive layer, and this flat portion abuts against the non-sintered lamination sheet at the time of manufacturing the intermediate product, which can prevent the excessive local load from being applied to the non-sintered substrate and the non-sintered lamination sheet, thus preventing cracks from causing to the non-sintered substrate and the non-sintered lamination sheet.

In a case of less than 3% in the width ratio of the flat portion with respect to the conductive layer, the width of the flat portion is too small, so that only less crack generation preventing effect is obtainable. It may be preferred that this width ratio is as much as large, but it will be difficult to be made to 100% in consideration of the conductive layer formation by a printing method mentioned later.

In a further aspect of the manufacturing method of the present invention, there may be also provided a method of manufacturing a gas sensor element comprising the steps of:

preparing a non-sintered substrate;

printing a metal past on a surface of the non-sintered substrate so as to form a conductive layer thereon, the metal paste having a viscosity of 200±50 [Pa·s] at a temperature of 20° C.;

forming a flat portion on a surface of the conductive layer formed of the metal paste;

laminating a non-sintered lamination sheet on the surface of the conductive layer on the non-sintered substrate so as to provide an intermediate product; and

sintering the thus laminated intermediate product.

According to this method, the flat portion is also formed to the protruded front end portion of the conductive layer by applying the metal paste, and this flat portion abuts against the non-sintered lamination sheet at the time of manufacturing the intermediate product, which can prevent the excessive local load from being applied to the non-sintered substrate and the non-sintered lamination sheet, thus preventing cracks from causing to the non-sintered substrate and the non-sintered lamination sheet.

In a case of the metal paste being less than 200±50 [Pa·s] at a temperature of 20° C., there is a fear of no formation of the aimed conductive layer because of too small viscosity, and on the other than, in a case of the metal paste being more than 200±50 [Pa·s] at a temperature of 20° C., there is a fear that the flat portion formed may have too small width and, hence, the desired crack generation preventing effect is not obtainable.

In a still further aspect, there may be also provided a method of manufacturing a gas sensor element comprising the steps of:

preparing a non-sintered substrate;

printing a metal paste on a surface of the non-sintered substrate for a conductive layer;

drying the metal paste so as to form the conductive layer;

forming a flat portion by pressurizing the conductive layer so that the flat portion has a width more than 3% of a width of the conductive layer;

laminating a non-sintered lamination sheet on the surface of the conductive layer on the non-sintered substrate so as to provide an intermediate product; and

sintering the thus laminated intermediate product.

According to this method, the flat portion having a predetermined width ratio is also formed to the protruded front end portion of the conductive layer by applying the metal paste, and this flat portion abuts against the non-sintered lamination sheet at the time of manufacturing the intermediate product, which can prevent the excessive local load from being applied to the non-sintered substrate and the non-sintered lamination sheet, thus preventing cracks from causing to the non-sintered substrate and the non-sintered lamination sheet.

In these manufacturing method, the conductive layer may comprise a heat generation portion and a lead portion for connecting the heat generation portion to an external element of the gas sensor element, and-the substrate may comprise a heater sheet provided with a conductive layer.

The conductive layer may comprise an electrode and a lead portion for connecting the heat generation portion to an external element of the gas sensor element, and the substrate may comprise a solid electrolytic sheet provided with a pair of conductive layers so as to constitute an electrochemical cell.

In the above embodiments of the manufacturing method of the gas sensor element, the non-sintered substrate and the non-sintered lamination sheet are substrate and sheet before the sintering process, and the width of the flat portion is formed in a direction normal to the longitudinal direction of the substrate in which the conductive layer extends. Furthermore, the conductive layer is a layer formed of a metal layer capable of being electrically conductive. The metal paste may be formed from more than one kind of noble metal such as Au, Pt, Pd and Rh, a resin and a solvent, which are mixed with each other. The conductive layer may be formed by drying the solvent in the metal paste.

Further, it is to be noted that the present invention will be made more clear from the following descriptions made with reference to the accompanying drawings.

### BRIEF DESCRIPTION OF THE DRAWINGS

In the accompanying drawings:

FIG. 1 is a sectional view of a gas sensor element according to a first embodiment of the present invention;

FIG. 2 is a developed perspective view of the gas sensor element of FIG. 1;

FIG. 3 is a sectional view taken along the line III-III in FIG. 1, in which a support member covers electrodes;

FIG. 4 is a view similar to FIG. 3, in which the support member, however, does not cover the electrodes;

FIG. 5 is a view similar to FIG. 3, in which a plurality of rectangular support members are disposed;

FIG. 6 is a view similar to FIG. 3, in which a plurality of elliptical support members are disposed;

FIG. 7 is a view similar to FIG. 3, in which a plurality of circular support members are disposed;

FIG. 8 is a view similar to FIG. 3, in which a plurality of support members are disposed in zigzag form;

FIG. 9 is a partial sectional view taken along the line I—I in FIG. 1 showing a ratio in sectional area of the support member and a gas measurement chamber;

FIG. 10 is a graph showing a relationship between a time and a NOx concentration;

FIG. 11 is a sectional view, corresponding to FIG. 1, representing a second embodiment of a gas sensor element of the present invention;

FIG. 12 is a sectional view taken along the line XII—XII in FIG. 11 and illustrates a state of forming a support member according to the second embodiment;

FIG. 13 is a sectional view, corresponding to FIG. 1, representing a third embodiment of a gas sensor element of the present invention;

FIG. 14 is a sectional view taken along the line XIV—XIV in FIG. 13 and illustrates a state of forming a support member according to the third embodiment;

FIG. 15 is a sectional view of a gas sensor element manufactured in accordance with an embodiment (first) of a gas sensor element manufacturing method of the present invention;

FIG. 16 is a developed perspective view of the gas sensor element of FIG. 15 before a sintering treatment;

FIG. 17 is a plan view illustrating a state that a conductive layer is formed on a surface of a non-sintered heat sheet of the gas sensor element of FIG. 15 (16);

FIG. 18 is a sectional view taken along the line XVIII—XVIII in FIG. 17, showing the conductive layer as a heating section in an enlarged scale;

FIG. 19 is a sectional view showing the conductive layer of FIG. 15(16) as a lead section in an enlarged scale;

FIG. 20 is an illustrated sectional view showing a state that a binder agent is applied to the surface of a conductive layer formed on a non-sintered heater sheet of the embodiment shown in FIG. 15(16);

FIG. 21 is an illustrated sectional view showing a state that a binder agent is applied to the surface of a conductive layer formed on a non-sintered solid electrolytic sheet of the embodiment shown in FIG. 15(16);

FIG. 22 is an illustrated sectional view showing a state that a non-sintered cover sheet is laminated on the surface of a conductive layer formed on a non-sintered heater sheet of the embodiment shown in FIG. 15(16);

FIG. 23 is an illustrated sectional view showing a state that non-sintered spacers are applied to both the surfaces of a conductive layer formed on a non-sintered solid electrolytic sheet of the embodiment shown in FIG. 15(16);

FIG. 24 is an illustrated sectional view showing a state that a metal paste is screen-printed on a surface of a non-sintered heater sheet and then dried to thereby form a conductive layer having a circular section, according to another embodiment of the gas sensor element manufacturing method of the present invention;

FIG. 25 is an illustrated sectional view showing a state that a metal paste is screen-printed on a surface of a non-sintered solid electrolytic sheet and then dried to thereby form a conductive layer having a circular section, according to another embodiment of the gas sensor element manufacturing method of the present invention;

FIG. 26 is an illustrated sectional view showing a state that a metal paste is screen-printed on a surface of a non-sintered solid electrolytic sheet and then dried to thereby form a conductive layer having a circular section, according to another embodiment of the gas.-sensor element manufacturing method of the present invention;

FIG. 27 is an illustrated sectional view showing a state that a conductive layer of the non-sintered solid electrolytic sheet is pressurized by means of press according to another embodiment of the gas sensor element manufacturing method of the present invention;

FIG. 28 is a sectional view of a gas sensor element manufactured in accordance with another (second) embodiment of a gas sensor element manufacturing method of the present invention;

FIG. 29 is a sectional view of a gas sensor element manufactured in accordance with a further (third) embodiment of a gas sensor element manufacturing method of the present invention;

FIG. 30 is a sectional view, similar to FIG. 1, showing a conventional gas sensor element;

FIG. 31 is a plan view of the gas sensor element of FIG. 30;

FIG. 32 is a sectional of the gas sensor element of FIG. 30 taken along the line XXX—XXX;

FIG. 33 is a plan view showing a heater section, of the gas sensor element of FIG. 30, to which cracks are generated; and

FIG. 34 is a sectional view taken along the line XXXIV—XXXIV in FIG. 33.

### DESCRIPTION OF THE PREFERRED EMBODIMENTS

Preferred embodiments of the gas sensor element of the present invention will be described hereunder with reference to the accompanying drawings.

### First Embodiment

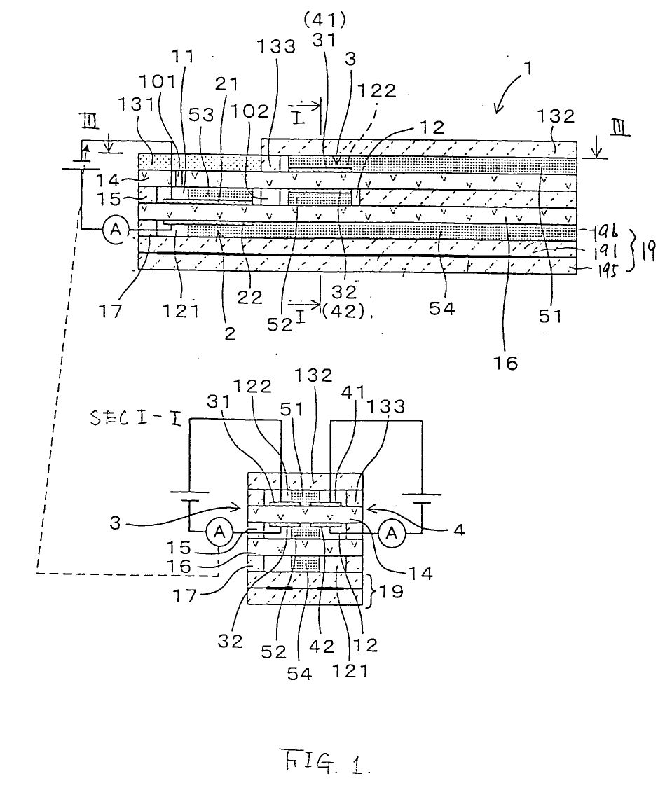

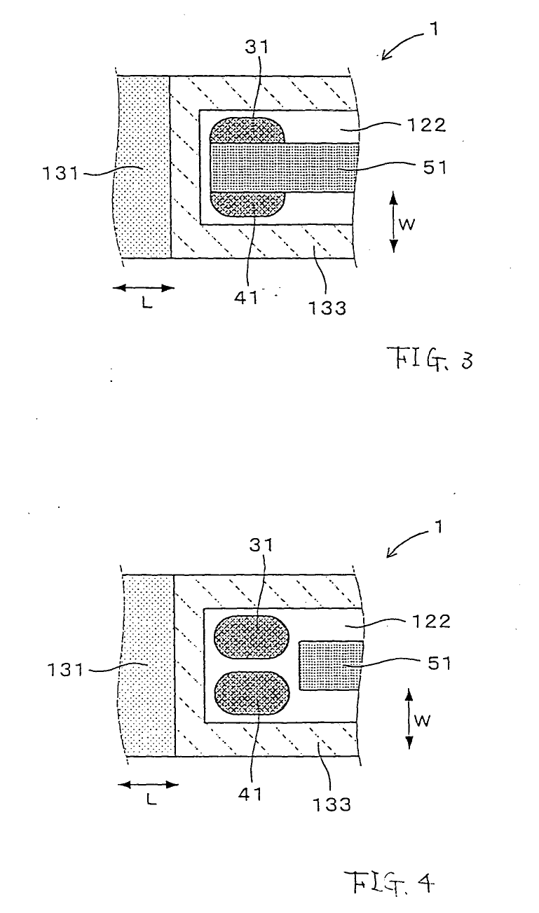

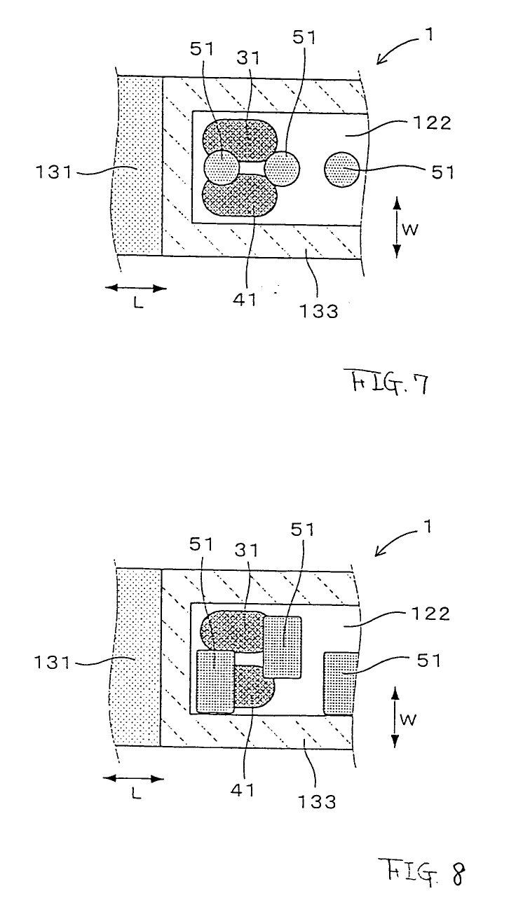

A first embodiment of a gas sensor element will be first described hereunder with reference to FIGS. 1 to 10.

In this embodiment, a gas sensor element (or merely gas sensor) 1 is a sensor for detecting NOx concentration in an exhaust gas, as a gas to be measured, from an engine of a vehicle.

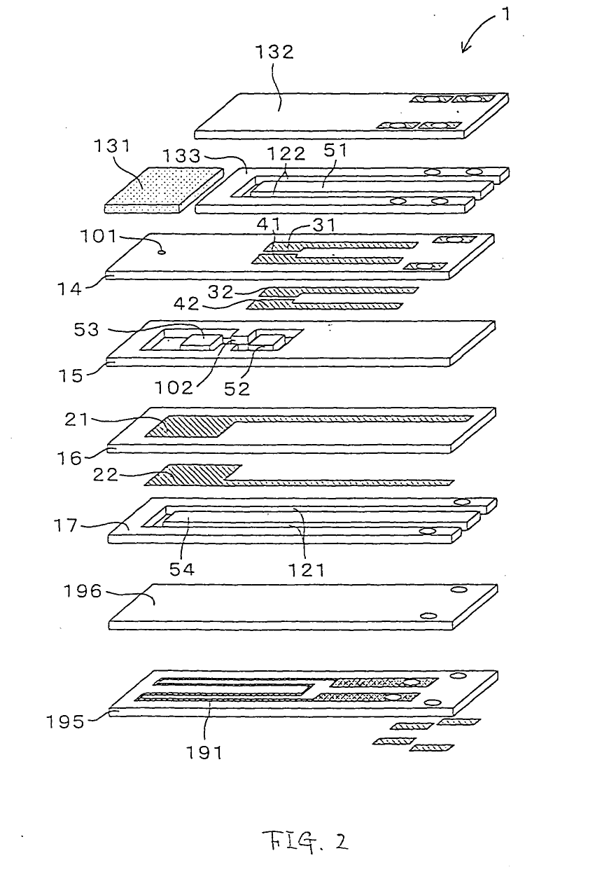

The gas sensor element 1 is provided with, as shown in FIGS. 1 and 2, gas measurement chambers 11 and 12, a pump cell 2, a monitor cell 3, a sensor cell 4 and a heater 19. The gas measurement chambers 11 and 12 each has a structure in which the gas to be measured (which may be called merely measurement gas for the sake of easy understanding) can be introduced under a predetermined diffusion resistance.

The pump cell 2 comprises an oxygen ion conductive solid electrolytic sheet 16 and a pair of electrodes 21 and 22 formed on the surface of the sheet 16. One electrode 21 is disposed in the gas measurement chamber 11 and the other one electrode 22 is disposed in a reference gas chamber 121.

Inside the gas measurement chamber 11, an exhaust gas from an engine is introduced through a porous sheet 131 and a gas inducing port 101. The pump cell 2 acts to regulate or control oxygen concentration in the exhaust gas in the gas introduced in the gas measurement chamber 11 by applying voltage to the paired electrodes 21 and 22. The exhaust gas subjected to the oxygen concentration control is thereafter introduced from the gas measurement chamber 11 into the other gas measurement chamber 12 through a diffusion resisting passage 102.

On the other hand, the monitor cell 3 comprises an oxygen ion conductive solid electrolytic sheet 14 and a pair of electrodes 31 and 32 formed on the surface of the sheet 14. One electrode 31 is disposed inside a reference gas chamber 122 into which atmosphere is introduced and the other electrode 32 is disposed inside the gas measurement chamber 12.

The monitor cell 3 acts to measure an oxygen ion current passing through the paired electrode 31 and 32 on the basis of a difference in the oxygen concentrations in the gas measurement chamber 12 and the reference gas chamber 122 and then detect the oxygen concentration in the gas measurement chamber 12. Then, in accordance with the detected oxygen ion current, the voltage to be applied to the pump cell 2 is regulated.

The sensor cell 4 comprises the oxygen ion conductive solid electrolytic sheet 14 and a pair of electrodes 41 and 42 formed on the surface of the sheet 14. One electrode 41 is disposed inside the reference gas chamber 122 into which atmosphere is introduced and the other electrode 42 is disposed inside the gas measurement chamber 12.

The sensor cell 4 acts to-decompose the NOx in the exhaust gas by the electrode 42 and then measure a change of the oxygen concentration generated in accordance with the decomposed amount of the NOx as an oxygen ion current passing through the paired electrodes 41 and 42, thus obtaining the NOx concentration.

Further, the heater 19 acts to heat the pump cell 2, the monitor cell 3 and the sensor cell 4 to their predetermined activation temperatures and comprises an insulating heater sheet 195, an insulating coat heater sheet 196 and a heating element 191 disposed between these heater sheets. The heating element 191 generates heat through the current conduction between the heater sheets 195 and 196.

The gas sensor element 1 of this embodiment comprises a porous sheet 131, a shield sheet 132, a spacer 132 constituting the reference gas chamber 122, the solid electrolytic sheet 14 constituting the monitor cell 3 and the sensor cell 4, a spacer 15 constituting the gas measurement chambers 11 and 12, the solid electrolytic sheet 16 constituting the pump cell 2, a spacer 17 constituting the other reference gas chamber 121, and the heater sheet 195 on which the coat heater sheet 196 and the heating element 191 are disposed. The gas sensor element 1 is formed by laminating these sheets and elements in the illustrated or predetermined order.

Furthermore, as shown in FIGS. 1 and 2, the spacer 133 is formed between the solid electrolytic sheet 14 constituting the monitor cell 3 and the sensor cell 4 and the shield sheet 132 opposing to the solid electrolytic sheet 14, and this spacer 133 forms the reference gas chamber 122 in which the atmosphere contacts the electrodes 41 and 42. The shield sheet 132 and the spacer 133 are formed on the side on which the electrodes 31 and 32 of the solid electrolytic sheet 14 are formed.

Next, with reference to FIG. 3, a support member for supporting (bearing) pressing force in the lamination direction of the solid electrolytic sheet 14 and the shield sheet 132 is disposed in the reference gas chamber 122.

The support member 51 support a portion between the solid electrolytic sheet 14 and the shield sheet 132 and between the electrodes 31, 41 and the shield sheet 132 so as to prevent these portions (i.e., spaces) from being reduced in size.

The reference gas chamber 122 has a long scale in its longitudinal direction shown in FIG. 9, and the support member 51 is supported, at its central portion in a width direction W of the reference gas chamber 122 normal to the longitudinal direction L thereof. Accordingly, a portion, which is most likely to be flexed, of the shield sheet 132, i.e., the central portion in the width direction, can be supported by the support member 51.

The gas sensor element 1 is itself formed to have a long scale and the longitudinal direction of the reference gas chamber 122 accords with the longitudinal direction of the gas sensor element 1.

With further reference to FIG. 9, in this embodiment, the sectional area A (thickened broken line area) of the support member in a section normal to the longitudinal direction L is of about 35% of the sectional area B (thickened solid line area) of the reference gas chamber 122 in the section normal to the longitudinal direction L. According to such structure, it becomes possible to prevent the sectional area of the atmosphere inducing passage of the reference gas chamber 122 from being reduced in size, and the deterioration of responsibility at the time of the detection of the NOx concentration in the measurement of the gas sensor element 1.

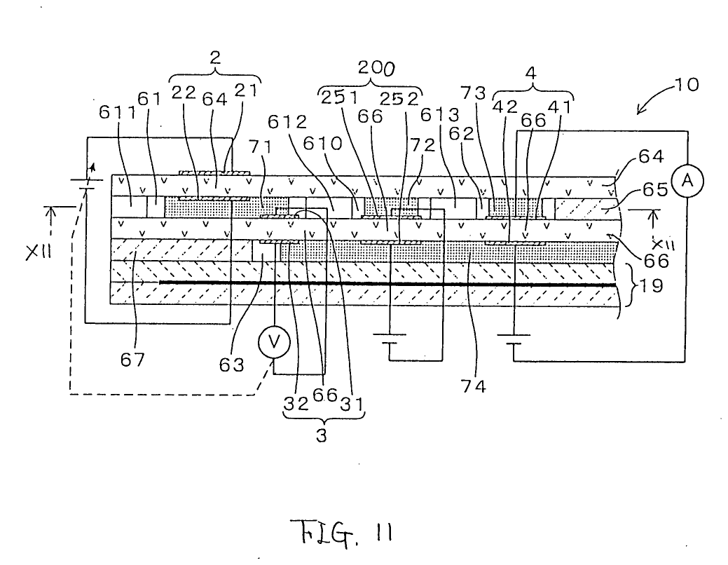

This deterioration in the responsibility will appear as a delay in detection and an error of a detected concentration. FIG. 10 is a graph showing a relationship between the actual NOx concentration and the detected NOx concentration, in which the axis of abscissa represents a time and the axis of ordinate represents the NOx concentration.

In the delay in the detection, as shown in FIG. 10, the change of the detected concentration appears in a delayed manner with respect to the change of the actual NOx concentration, and accordingly, the delay in the detection deteriorates the responsibility. On the other hand, the error in the detected concentration will appear as over-shoot X1 or under-shoot X2, in which, at the time when the actual NOx concentration changes, the over-shoot X1 shows a case that the detected NOx concentration shows a value higher than the actual NOx concentration and the under-shoot X2 shows a case that the detected NOx concentration shows a value lower than the actual NOx concentration. Thus, the responsibility becomes worse.

Furthermore, as shown in FIG. 3, the support member 51 in the described embodiment is also disposed between the electrodes 31, 41 and the shield sheet 132 so as to cover the electrodes 31, 41.

The support member 51, on the other hand, maybe disposed between the solid electrolytic sheet 14 and the shield 132.

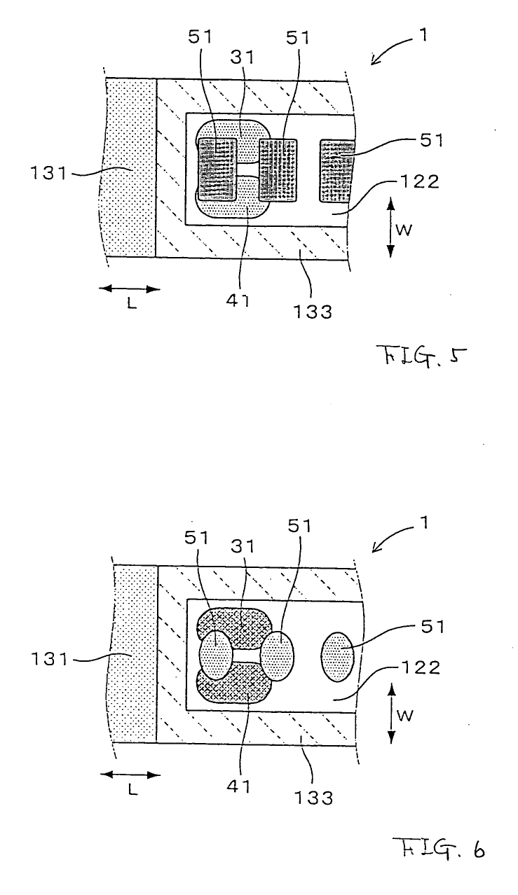

Furthermore, the support member 51 may be divided into a plurality of portions so as to have various sectional shapes such as rectangular shape, elliptical shape and circular shape as shown in FIGS. 5 to 7, respectively. Further, it is desired that the thus divided support portions 51 at their central portions in the width direction W.

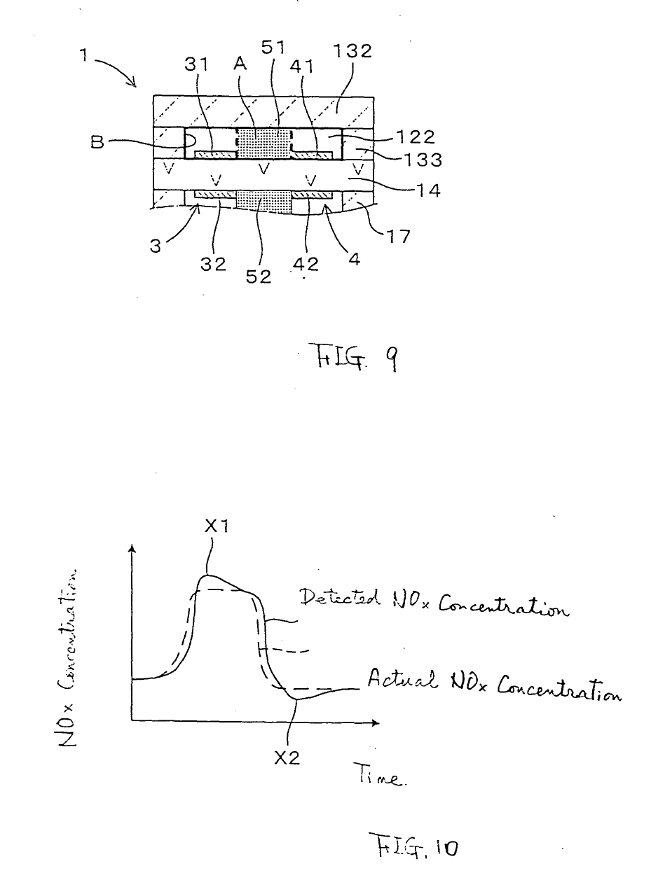

On the other hand, as shown in FIG. 8, the divided support portions may be arranged in a zigzag form. In this example, as shown in FIG. 10, it is desired to be supported at their central portions in the width direction W.

Referring back to FIG. 1, the spacer 15 forming the gas measurement chamber 12, in which the exhaust gas, after regulating the oxygen concentration, contacts the electrodes 32 and 42, is formed between the solid electrolytic sheet 14 constituting the monitor cell 3 and the sensor cell 4 and the solid electrolytic sheet 16 disposed at a position opposing to the shield sheet 132 with respect to the sheet 14. In this gas measurement chamber 12, another support member 52 for supporting (bearing) pressing force in the lamination direction of the solid electrolytic sheets 14 and 16.

This support member 52 supports a portion between the solid electrolytic sheets 14 and 16 and a portion between the electrodes 32, 42 and the solid electrolytic sheet 16 to thereby prevent the solid electrolytic sheets 14 and 16 from being reduced in size or distance therebetween.

Furthermore, as shown in FIG. 1, the gas measurement chamber 11 is formed, for rendering the exhaust gas to contact the electrode 21, by the spacer 15, between the solid electrolytic sheets 14 and 16, and a further support member 53 is disposed in this gas measurement chamber 11 so as to support a portion between the solid electrolytic sheets 14 and 16 and a portion between the electrode 21 and the solid electrolytic sheet 14.

As mentioned above, according to the structure of this embodiment, the solid electrolytic sheets 14 and 16 are also prevented from being reduced in size therebetween also by this support member 53.

Furthermore, the spacer 17 forming the reference gas chamber 121, in which the atmosphere contacts the electrode 22, is formed between the solid electrolytic sheet 16 constituting the pump cell 2 and the cover heater sheet 196 disposed at a position opposing to the solid electrolytic sheet 14 with respect to the sheet 16. In this reference gas chamber 121, a further support member 54-for supporting pressing force in the lamination direction of the solid electrolytic sheet 16 and the cover heater sheet 196.

This support member 54 supports a portion between the solid electrolytic sheet 16 and the cover heater sheet 196 and a portion between the electrode 22 and the cover heater sheet 196.

Further, it is to be noted that the above support members 52, 53 and 54 have substantially the same as or identical to the support member 51 in size, shape, sectional area, arrangement and so on, and the support members 51 to 54 of this embedment will be preferably made from an insulating material such as alumina.

Incidentally, the paired electrodes 21, 22 of the pump cell 2, the paired electrodes 31, 32 of the monitor cell and the electrode 41 of the sensor cell 4 have substantially no decomposing activity with respect to the NOx. More specifically, these electrodes 21, 22, 31, 32 and 41 are composed of porous cermet electrodes containing, as main components, Pt and Au.

On the other hand, the electrode 42 of the sensor cell 4 has the decomposing activity with respect to the NOx. More specifically, this electrode 42 is composed of the porous cermet electrode containing, as main components, Pt and Rh.

The respective solid electrolytic sheets 14 and 16 are composed of solid electrolytic substance, such as zirconia or ceria, having oxygen ion conductive property. Further, the shield sheet 132 and the respective spacers 133, 15, 17, the heater sheet 195 and the coat heater sheet 196 are formed of insulating material such as alumina.

According to the gas sensor element 1 of the embodiment described above, the support members 51 to 54 are disposed in the respective gas chambers 122, 12, 11, 121 for supporting or bearing the pressing force in the lamination direction of the respective sheets 131, 132, 14, 16, 195, 196 and the spacers 133, 15, 17. Because of the arrangement of the support members 51 to 54, even if the pressing force is applied in the lamination direction of the gas sensor element 1, the respective sheets 132, 14, 16, 196 can be prevented from being flexed or bent towards the respective gas chambers 122, 12, 11, 121, thus providing the improved strength to the gas sensor element.

Moreover, at a time of manufacturing the gas sensor element 1 of the structure mentioned above, the respective sheets 131, 132, 14, 16, 195, 196 and the spacers 133, 15, 17 are pressurized in the laminated state, and at this time, the pressing force is applied between the respective sheets 132, 14, 16, 196. In such case, this pressing force can be supported by these support members 51 to 54 disposed in the respective gas chambers 122, 12, 11, 121 and the flexing of the respective sheets 132, 14, 16, 196 towards the gas chambers 122, 12, 11, 121 can be effectively suppressed, thus preventing cracks from causing to these sheets.

In addition, after the pressurizing process mentioned above, the sintering process is performed to thereby manufacture the gas sensor element 1. In the present embodiment, since the respective sheets 131, 132, 14, 16, 195, 196 and the respective spacers 133, 15, 17 are formed from different materials or substances, there may cause a fear that the respective sheets 132, 14, 16, 196 will be flexed towards the gas chambers 122, 12, 11, 121 because of differences in thermal shrinkage percentage (coefficient of contraction) at the time of sintering.

Even in such case, however, according to the structure of the present embodiment, the flexing of the sheet can be suppressed from causing by the support members 51 to 54, thus effectively preventing cracks from being generated to the respective sheets 132, 14, 16, 196.

Furthermore, in an alternation, the spacers 133, 15, 17 may be formed by coating a binding agent or like for forming the spacer on the surfaces of the respective sheets 196, 16, 14. Further, the respective support members 51 to 54 may be also formed by coating the bonding agent or like for forming the support member on the surfaces of the respective sheets 196, 16, 14. In such alternation, as the bonding agents for forming the spacers and for forming the support members, there is used an alumina paste obtained by kneading fine alumina powders and a solvent in which a binder is dissolved. There may be used, as the binder, for example, polyvinyl-alcohol, and as the solvent, terpineol.

Furthermore, in an alternation, there may be used the spacers 133, 15, 17 formed with the gas chambers 122, 12, 11, 121 by preliminarily cutting the spacers 133, 15 17 in forms of the respective gas chambers. There may be also used the support members 51 to 54 which are preliminarily formed so as to provide their shapes. In the case mentioned above, the respective sheets 131, 132, 14, 16, 195, 196 and spacers 133, 15, 17 would be joined together by means of bonding agent or like.

In such alternation, as the bonding agents for forming the spacers and for forming the support members, there is also used an alumina paste obtained by kneading fine alumina powder and a solvent in which a binder is dissolved. There may be used, as the binder, for example, polyvinyl-alcohol, and as the solvent, terpineol.

In the above case, the respective sheets 131, 132, 14, 16, 195, 196 and the spacers 133, 15, 17 may be bonded through the sintering process without using any binding agent.

### Second Embodiment

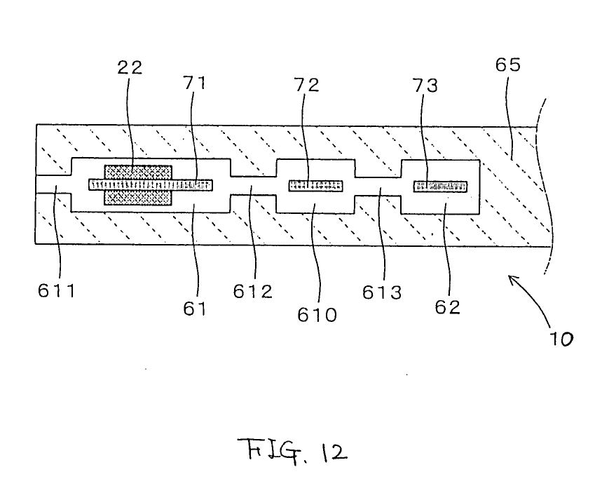

The second embodiment of the gas sensor element according to the present invention will be described hereunder with reference to FIGS. 11 and 12.

This second embodiment differs from the first embodiment mainly in the arrangement of support members 71 to 74.

The gas sensor element 10 of this second embodiment is provided with, as shown in FIGS. 11 and 12, gas measurement chambers 61, 610 and 62, a first pump cell 2 and a second pump cell 200, a monitor cell 3, a sensor cell 4 and a heater 19.

The gas sensor element 10 of this embodiment is constructed by laminating a solid electrolytic sheet .64 constituting the first pump cell 2, a spacer 65 constituting the gas measurement chambers 61, 610, 62, a solid electrolytic sheet 66 constituting the second pump cell 200, the monitor cell 3 and the sensor cell 4, a spacer 67 constituting a reference gas chamber 63, and a heater portion 19 including a cover heater sheet 196 and a heater sheet 195.

The first pump cell 2 comprises an oxygen ion conductive solid electrolytic sheet 64 and a pair of electrodes 21 and 22 formed on the surface of the sheet 64. One electrode 21 is exposed to the atmosphere and the other one electrode 22 is disposed inside a reference gas chamber 61.

Inside the gas measurement chamber 61, an exhaust gas from an engine is introduced through a gas introducing passage 611. The first pump cell 2 acts to regulate or control oxygen concentration in the exhaust gas in the gas introduced in the gas measurement chamber 61 by applying voltage to the paired electrodes 21 and 22. The exhaust gas subjected to the oxygen concentration control is thereafter introduced from the gas measurement chamber 61 into the other gas measurement chamber 610 through a diffusion resisting passage 612.

On the other hand, the monitor cell 3 of this second embodiment comprises an oxygen ion conductive solid electrolytic sheet 66 and a pair of electrodes 31 and 32 formed on the surface of the sheet 14. One electrode 31 is disposed in the a gas measurement chamber 61 and the other electrode 32 is disposed in the a reference gas chamber 63 into which the atmosphere is introduced.

The monitor cell 3 acts to measure an electromotive force generated between the paired electrodes 31 and 32 on the basis of a difference in the oxygen concentrations in the gas measurement chamber 61 and the reference gas chamber 63 and then detect the oxygen concentration in the gas measurement chamber 61. Then, in accordance with the detected electromotive force, the voltage to be applied to the pump cell 2 is regulated.

The second pump cell 200 is composed of an oxygen ion conductive solid electrolytic sheet 66 and a pair of electrodes 251 and 252 formed on the surface of the sheet 66. One electrode 251 is disposed in a gas measurement chamber 610 and the other one electrode 252 is disposed in a reference gas chamber 63.

The first pump cell 200 of this embodiment acts to regulate or control oxygen concentration in the exhaust gas in the gas introduced in the gas measurement chamber 610 by applying voltage to the paired electrodes 251 and 252. The exhaust gas subjected to the oxygen concentration control is thereafter introduced from the gas measurement chamber 610 into the other gas measurement chamber 62 through a diffusion resisting passage 613.

The sensor cell 4 of this embodiment comprises the oxygen ion conductive solid electrolytic sheet 66 and a pair of electrodes 41 and 42 formed on-the surface of the sheet 14. One electrode 41 is disposed in the gas measurement chamber 62 and the other electrode 42 is disposed in the reference gas chamber 63 into which the atmosphere is introduced.

The sensor cell 4 acts to decompose the NOx in the exhaust gas by the electrode 41 and then measure a change of the oxygen concentration generated in accordance with the decomposed amount of the NOx as an oxygen ion current passing through the paired electrodes 41 and 42, thus obtaining the NOx concentration.

The heater 19 is identical to that of the first embodiment.

In the gas measurement chambers 61, 610, 62, there are arranged support members 71 to 73 for supporting portions between the respective solid electrolytic sheets 64 and 66. According to the location of these support members 71 to 73, the respective solid electrolytic sheets 64 and 66 can be prevented from being flexed towards the gas measurement chambers 61, 610 and 62, respectively, and hence, the generation of cracks to the respective sheets 64 and 66 can be effectively prevented.

In addition, a further support member 74 may be disposed in the reference gas chamber 63 so as to support a portion between the solid electrolytic sheet 66 and the cover heater sheet 196. According to the arrangement of this support member 74, the respective solid electrolytic sheets 66 and 196 can be prevented from being flexed towards the reference gas chamber 63, and hence, the generation of cracks to the respective sheets 66 and 196 can be effectively prevented.

Other structures or arrangement of this second embodiment and advantageous effects attained thereby are substantially the same as or identical to those of the first embodiment.

### Third Embodiment 3

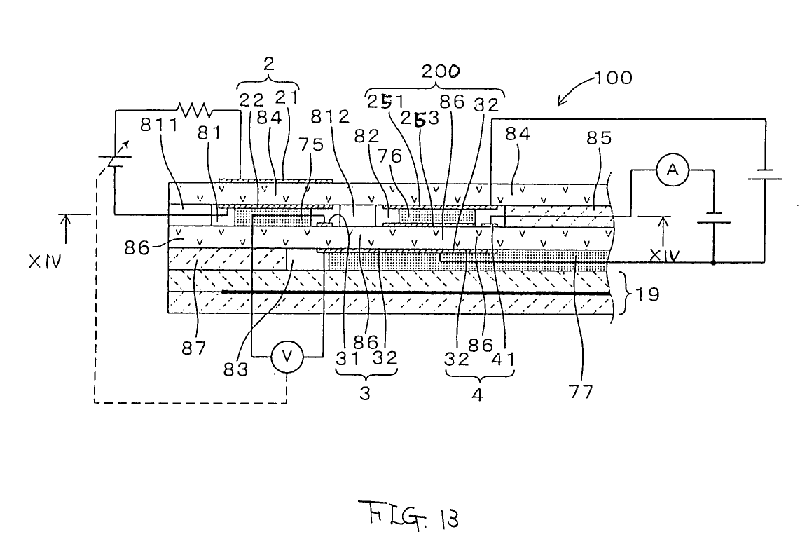

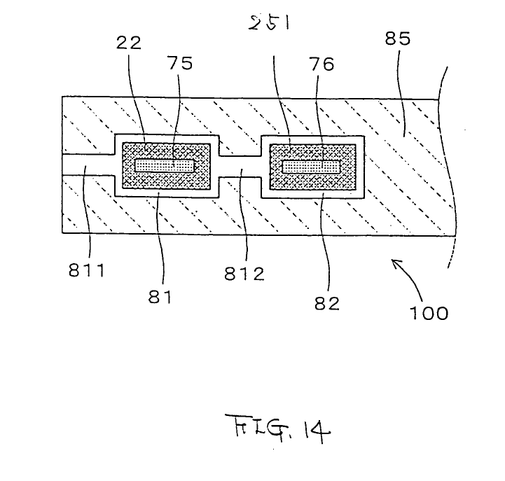

The third embodiment of the gas sensor element of according to the present invention will be described hereunder with reference to FIGS. 13 and 14.

This third embodiment differs from the first embodiment mainly in the arrangement of support members 75 to 77.

The gas sensor element 100 of this third embodiment is provided with, as shown in FIGS. 13 and 14, gas measurement chambers 81 and 82, a first pump cell 2 and a second pump cell 200, a monitor cell 3, a sensor cell 4 and a heater 19.

The gas sensor element 100 of this embodiment is constructed by laminating a solid electrolytic sheet 84 constituting the first pump cell 2, a spacer 85 constituting the gas measurement chambers 81, 82, a solid electrolytic sheet 86 constituting the second pump cell 200, the monitor cell 3 and the sensor cell 4, a spacer 87 constituting a reference gas chamber 83, and a heater portion 19 including a cover heater sheet 196 and a heater sheet 195.

The first pump cell 2 of this embodiment comprises the oxygen ion conductive solid electrolytic sheet 84 and a pair of electrodes 21 and 22 formed on the surface of the sheet 84. One electrode 21 is exposed to the atmosphere and the other one electrode 22 is disposed in the gas measurement chamber 81.

Inside the gas measurement chamber 81, an exhaust gas from an engine is introduced through a gas introducing passage 811. The first pump cell 2 acts to regulate or control oxygen concentration in the exhaust gas in the gas introduced in the gas measurement chamber 81 by applying voltage to the paired electrodes 21 and 22. The exhaust gas subjected to the oxygen concentration control is thereafter introduced from the gas measurement chamber 81 into the other gas measurement chamber 82 through a diffusion resisting passage 812.

On the other hand, the monitor cell 3 of this third embodiment comprises an oxygen ion conductive solid electrolytic sheet 86 and a pair of electrodes 31 and 32 formed on the surface of the sheet 86. One electrode 31 is disposed in the gas measurement chamber 81 and the other electrode 32 is disposed in the reference gas chamber 83 into which the atmosphere is introduced. The electrode 32 is utilized as an electrode for the second pump cell 200 and the sensor cell 4 as mentioned hereinafter.

The monitor cell 3 of this embodiment acts to measure an electromotive force generated between the paired electrodes 31 and 32 on the basis of a difference in the oxygen concentrations in the gas measurement chamber 81 and the reference gas chamber 83 and then detect the oxygen concentration in the gas measurement chamber 81. Then, in accordance with the detected electromotive force, the voltage to be applied to the pump cell 2 is regulated.

The second pump cell 200 is composed of an electrode 251 disposed on the surface of the oxygen ion conductive solid electrolytic sheet 84, a spacer 85 having an oxygen ion conductivity, the solid electrolytic sheet 86, an electrode 253 disposed on the surface of the sheet 86, and the electrode 32. These electrodes 251 and 253 are disposed inside the measurement gas chamber 81.

The second pump cell 200 further regulates the oxygen concentration in the exhaust gas introduced in the gas measurement chamber 82 by applying a voltage to the paired electrodes 251 and 32.

The sensor cell 4 of this embodiment comprises the oxygen ion conductive solid electrolytic sheet 86 and a pair of electrodes 41 and 32 formed on the surface of the sheet 86. One electrode 41 is disposed in the gas measurement chamber 82.

The sensor cell 4 of this embodiment acts to decompose the NOx in the exhaust gas by the electrode 41 and then measure a change of the oxygen concentration generated in accordance with the decomposed amount of the NOx as an oxygen ion current passing through the paired electrodes 41 and 32, thus obtaining the NOx concentration.

The heater 19 is identical to that of the first embodiment.

In the gas measurement chambers 81, 82, there are arranged support members 75 and 76 for supporting portions between the respective solid electrolytic sheets 84 and 86. According to the location of these support members 75 and 76, the respective solid electrolytic sheets 84 and 86 can be prevented from being flexed towards the gas measurement chambers 81 and 82, respectively, and hence, the generation of cracks to the respective sheets 84 and 86 can be effectively prevented.

In addition, a further support member 77 may be disposed in the reference gas chamber 83 so as to support a portion between the solid electrolytic sheet 86 and the cover heater sheet 196. According to the arrangement of the support member, the respective solid electrolytic sheets 86 and 196 can be prevented from being flexed towards the reference gas chamber 83, and hence, the generation of cracks to the respective sheets 86 and 196 can be effectively prevented.

Other structures or arrangement of this third embodiment and advantageous effects attained thereby are substantially the same as or identical to those of the first or second embodiment.

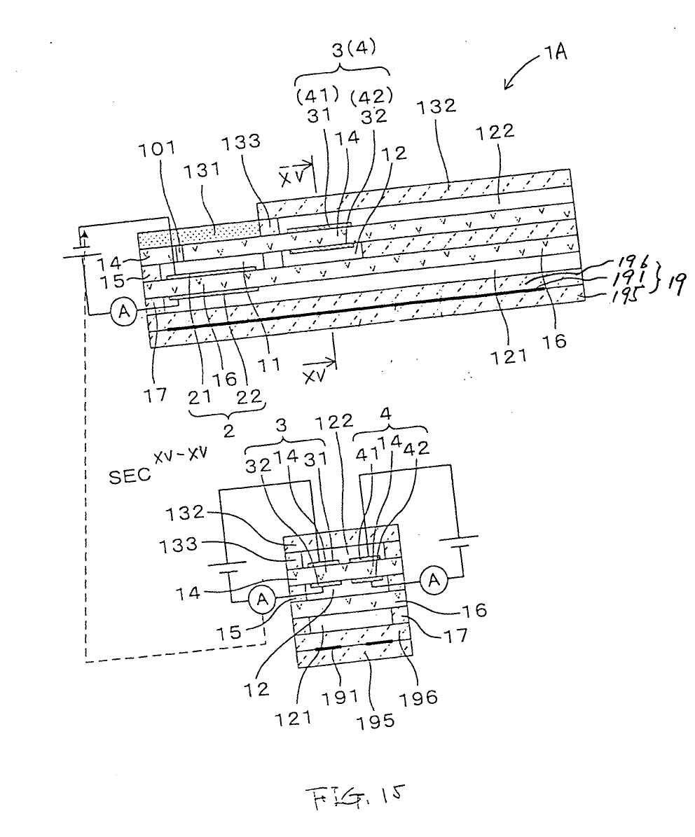

In the followings, a method of manufacturing a gas sensor element or gas sensor of the structure mentioned above will be described with reference to a gas sensor element 1A of FIGS. 15 and 16, which may be similar to that shown in FIGS. 1 and 2. Accordingly, same reference numerals of FIGS. 1 and 2 are added to the same or corresponding members or portions of FIGS. 15 and 16, and overlapped explanations thereof are herein omitted.

With reference to FIGS. 15 and 16, the pump cell 2 is formed by printing conductive layers 20 on both surfaces of the solid electrolytic sheet 16. The conductive layer 20 is composed of a pair of electrodes 21, 22 as electrode section, a pair of terminals 212, 222 as terminal section for connecting the electrodes 21 and 22 to external elements of the gas sensor element 1A, and a pair of leads 211, 221, as lead section, for connecting these electrode section and the terminal section to each other.

The monitor cell 3 is formed by printing conductive layers 30 on both surfaces of the solid electrolytic sheet 14. The conductive layer 30 is composed of a pair of electrodes 31, 32, as electrode section, and a pair of leads 311, 321, as lead section, for connecting the electrode section to an external element of the gas sensor element 1A.

The sensor cell 4 is formed by printing conductive layers 40 on both surfaces of the solid electrolytic sheet 14. The conductive layer 40 is composed of a pair of electrodes 41, 32, as electrode section, and a pair of leads 411, 421, as lead section, for connecting the electrode section to an external element of the gas sensor element 1A.

A conductive layer 190 is formed, through a printing process, on a surface of the heater sheet 195, and the conductive layer 190 is composed of a heating section 192 corresponding to the heating element 191 and a lead section 193 for connecting the heating section 192 to an external element of the gas sensor element 1A. Further, the heating section 192 (heating element 191) generates heat by designing its sectional area to be smaller than the sectional area of the lead section 193.

In the foregoing descriptions, the conductive layer may include a terminal section as a junction point in the connection of the lead section to the external element of the gas sensor element 1A. More concretely, in a non-sintered solid electrolytic sheet 140 in FIG. 16, the conductive layers 30 and 40 include terminals 310 and 410 for connecting the leads 321 and 421 to the external elements of the gas sensor element 1A.

Further, the paired electrodes 21, 22 of the pump cell 2, the paired electrodes 31, 32 of the monitor cell and the electrode 41 of the sensor cell 4 have substantially no decomposing activity with respect to the NOx. More specifically, these electrodes 21, 22, 31, 32 and 41 are composed of porous cermet electrodes containing, as main components, Pt and Au.

On the other hand, the electrode 42 of the sensor cell 4 has the decomposing activity with respect to the NOx. More specifically, this electrode 42 is composed of the porous cermet electrode containing, as main components, Pt and Rh.

The respective solid electrolytic sheets 14 and 16 are composed of solid electrolytic substance, such as zirconia or ceria, having oxygen ion conductive property. Further, the shield sheet 132 and the respective spacers 133, 15, 17, the heater sheet 195 and the cover (coat) heater sheet 196 are formed of insulating material such as alumina.

A gas sensor element manufacturing method according to the present invention will be specifically described hereunder through following preferred embodiments.

### Embodiment 1

In this embodiment, through experiment, of the gas sensor element manufacturing method, a conductive layer is formed by a printing step and a flat portion forming step.

That is, as shown in FIG. 17, in the printing step and the flat portion forming step, the conductive layer 190 is formed by a screen printing on a surface of a heater sheet 195 before the sintering process, which is denoted as non-sintered heater sheet 1950. In this screen printing, a metal paste is utilized for forming the conductive layer 190, and it is desirable to use, as this metal paste, a paste having viscosity of 200±50 [Pa·s] at a temperature of 20° C.

As such metal paste, there will be listed up: Pt, organic binder, a paste prepared by kneading alumina powder and terpineol as solvent. Zirconia powder may be substituted for the alumina powder, or Pt may be substituted with a paste including Pt and Rh or including Pt and Au.

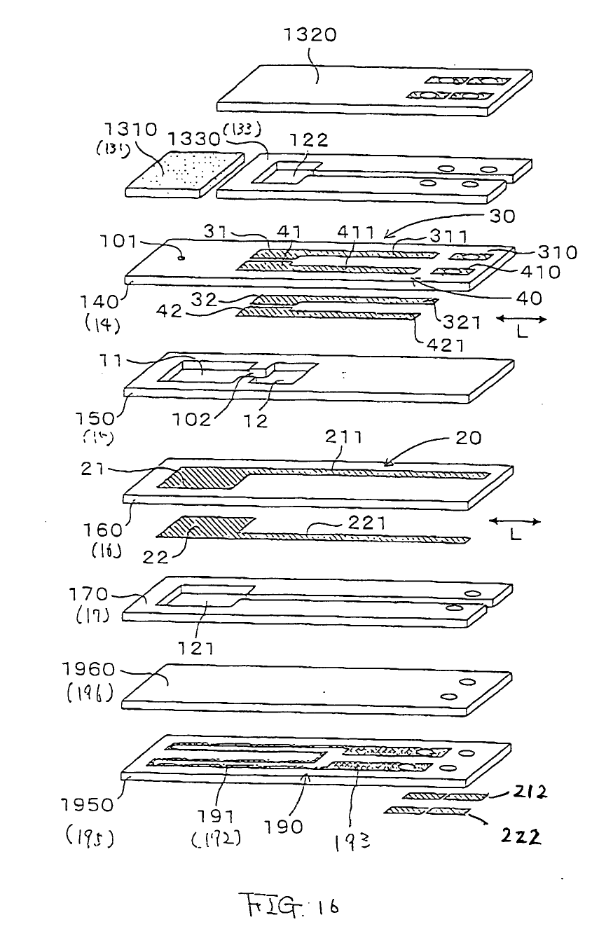

When the screen printing is carried out by using the paste of the type mentioned above, the metal paste is spread flatly on the surface of the non-sintered heater sheet 1950 because of low viscosity of the metal paste. The metal paste is thereafter dried to thereby form the conductive layer 190. In this process, a flat portion 199 is formed on the conductive layer 190 as shown in FIG. 18.:

With reference to FIG. 18, which is an enlarged sectional view taken along the line XVIII—XVIII in FIG. 17, showing a conductive layer forming portion in the width direction normal to the longitudinal direction L of the non-sintered heater sheet 1950. In the embodiment of the gas sensor element manufacturing method, there is adopted a metal paste having viscosity of 190[Pa ·s] at a temperature of 20° C., and accordingly, the width of the flat portion 199 of the conductive layer 190 is about 65% of the width B of the conductive layer 190 (A/B×100=65 (%)). Further, the width B of the conductive layer 190 means the width of the conductive layer 190 in a direction normal to the extending direction of the conductive layer on the non-sintered heater sheet 1950. In this embodiment, the conductive layer 190 is formed so as to extend in the longitudinal direction L of the non-sintered heater sheet 1950.

Furthermore, in the screen printing step and the flat portion forming step mentioned above with reference to the conductive layer 190, conductive layers 30 and 40 are formed on both the surfaces of a non-sintered solid electrolytic sheet 140, which is a sheet before the sintering step to the solid electrolytic sheet 14. Thereafter, flat portions 301 and 401 are formed to these conductive layers 30 and 40. In substantially the same process, the conductive layers 20 are formed on both the surfaces of a non-sintered solid electrolytic sheet 160, which is a sheet before the sintering step to the solid electrolytic sheet 16. Thereafter, flat portions 201 are formed to the conductive layers 20.

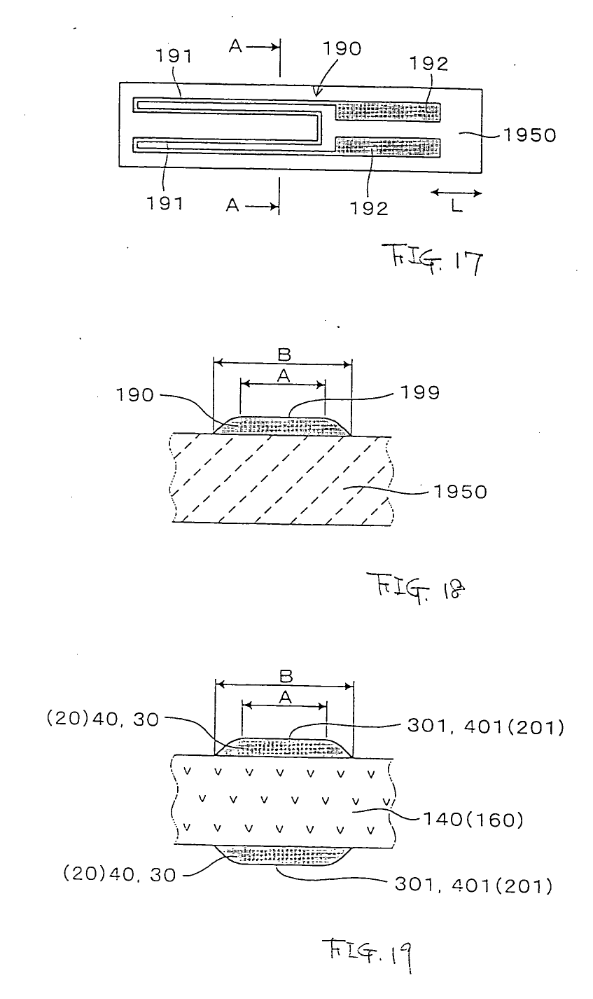

The above steps will be made clear with reference to FIG. 19, which is an enlarged sectional view, showing a conductive layer forming portion in the width direction normal to the longitudinal direction L of the non-sintered solid electrolytic sheets 140 and 160. In this embodiment, the width Of each of the flat portions 201, 301, and 401 of the conductive layers 20, 30 and 40 is about 50% of the width B of the conductive layers (A/B×100=50 (%)).

As mentioned above, the conductive layer 190 is formed on the non-sintered heater sheet 1950 and the conductive layers 30, 40, 20 are also formed on the non-sintered solid electrolytic sheets 140 and 160 through the screen printing step. Thereafter, in a laminating step, as shown in FIG. 16, a non-sintered cover (coat) heater sheet 1960, which is a sheet before the sintering process to the cover heater sheet 196, is laminated on the conductive layer 190 of the non-sintered heater sheet 1960. Then, a non-sintered spacer 170, which is a spacer before the sintering step to the spacer 17, is laminated on the surface of the non-sintered heater sheet 1960, and a non-sintered solid electrolytic sheet 160 as a non-sintered substrate is then laminated on the non-sintered spacer 170.

Furthermore, as shown in FIG. 16, a non-sintered spacer 150 as non-sintered lamination layer is laminated on the surface of the non-sintered solid electrolytic sheet 160, and the non-sintered solid electrolytic sheet 140 as non-sintered substrate is then overlapped on the surface of this non-sintered spacer 150. Furthermore, a non-sintered porous sheet 1310 and a non-sintered spacer 1330 as non-sintered lamination sheets are laminated on the surface of the non-sintered electrolytic sheet 140, and a non-sintered shield sheet 1320 is overlapped on the surface of the non-sintered spacer 1330.

As understood from the above, the non-sintered spacers 1310, 150 and 170 are spacers before the sintering treatment to the spacers 131, 15 and 17. The non-sintered porous sheet 1310 and the non-sintered shield sheet 1320 are also sheets before the sintering treatment to the porous sheet 131 and the shield sheet 132.

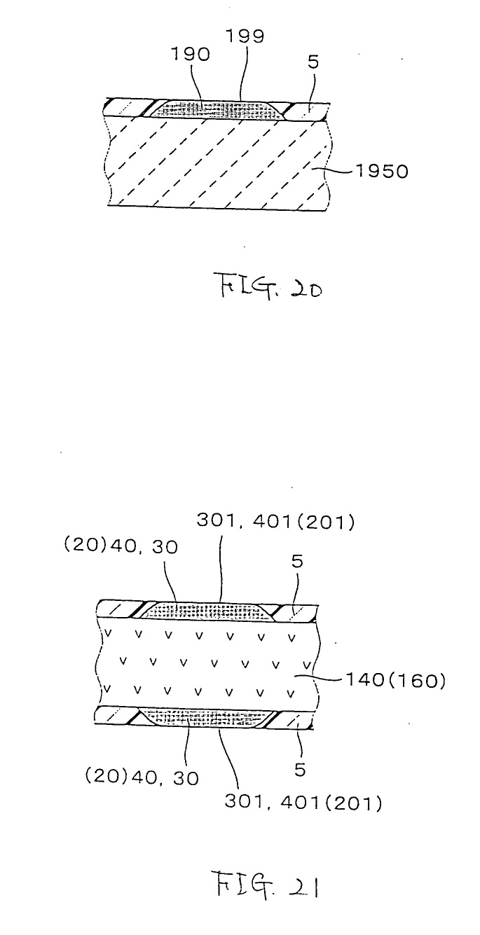

Further, as shown in FIGS. 20 and 21, bonding agent 5 is applied, at the overlapping process mentioned above, between the respective non-sintered sheets 310, 1320, 140, 160, 1950 and 1960, and the non-sintered spacers 1330, 150 and 170, respectively. As this bonding agent 5, there will be provided one obtained by kneading alumina, preferably having fine particle size, organic type binder and solvent. As the binding agent 5, there will be also provided one obtained by kneading zirconia, organic binder and solvent. In each binding agent, terpineol may be utilized as the solvent.

In this embodiment, as shown in FIG. 20, the binding agent 5 is coated on the surface of the non-sintered heater sheet 1950 on the side of the conductive layer 190 so as to be substantially flush with the flat portion 199 of the conductive layer 190. Further, as shown in FIG. 21, the binding agent 5 is coated on the surfaces of the non-sintered solid electrolytic sheets 140 and 160 on both the sides of the conductive layers 30 and 40 so as to be substantially flush with the flat portions 301, 401 and 201 of the conductive layers 30, 40 and 20.

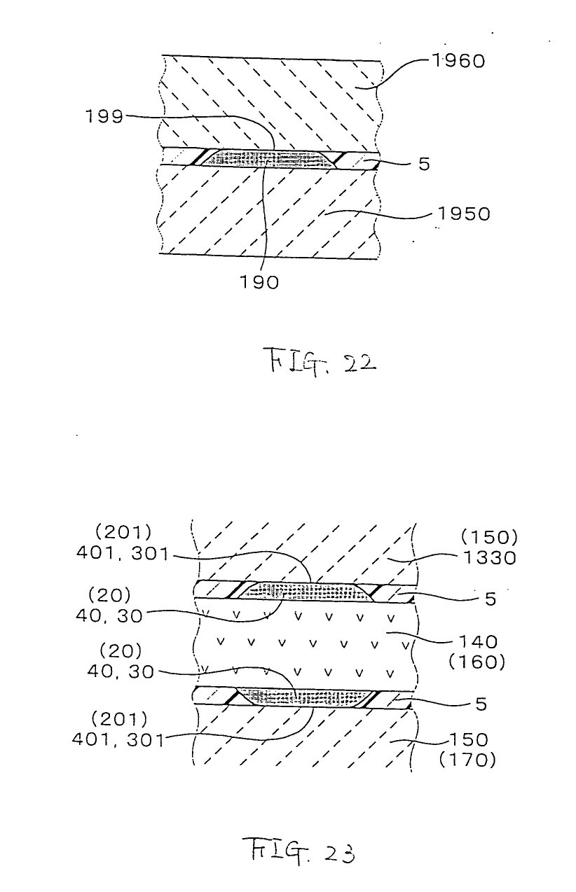

Thereafter, as shown in FIGS. 22 and 23, the respective non-sintered sheets 1310, 1320, 140, 160, 1950 and 1960 and the respective non-sintered spacers 1330, 150, 170 are pressurized in the stacked state to thereby provide a lamination layer structure and hence provide an intermediate product of the gas sensor element 1A. In this process, as shown in FIG. 20, the non-sintered cover heater sheet 1960 abuts against the flat surface portion 199 of the conductive layer 20 and the bonding agent 5, which are flatly formed on the surface of the non-sintered heater sheet 1950.

As shown in FIG. 23, the non-sintered spacers 1330 and 150 also abuts against the flat surface portions 301 and 401 of the lead portions 311, 321, 411 and 421, and the bonding agent 5 which are flatly formed on both side surfaces of the non-sintered solid electrolytic sheet 140. Further, since the electrodes 31, 32, 41 and 42 of the non-sintered solid electrolytic sheet 140 are arranged inside the gas measurement chambers 11 and 12, these electrodes do not abut against the non-sintered spacer 1330.

On the other hand, the non-sintered spacers 150 and 170 abuts against the flat surface portion 201 of the lead portions 211 and 221, flatly formed, and the bonding agent 5, on both side surfaces of the non-sintered solid electrolytic sheet 160. Further, since the electrodes 21 and 22 of the non-sintered solid electrolytic sheet 160 are arranged inside the reference gas chamber 121, these electrodes do not abut against the non-sintered spacers 150 and 170.

According to the reason mentioned above, it becomes possible to prevent the application of the local load between the respective non-sintered sheets 140, 160, 1950 and 1960 and the respective non-sintered spacers 1330, 150 and 170, whereby it is possible to prevent the cracks from causing to these non-sintered sheets 140, 160, 1950 and 1960 and the non-sintered spacers 1330, 150 and 170.

Thereafter, in the sintering process, the intermediate product as the laminated structure is sintered to thereby manufacture the gas sensor element 1A in which the respective sheets and the spacers mentioned above are laminated in the prescribed order.

Further, in an alternation, the non-sintered spacer 1330 maybe formed by applying a bonding agent, for forming the spacer, on the surface of the non-sintered shield sheet 1320 or non-sintered solid electrolytic sheet 140. The non-sintered spacer 150 may be formed also by-applying a bonding agent, for forming the spacer, on the surface of the non-sintered solid electrolytic sheet 140 or.160. Furthermore, the non-sintered spacer 170 may be formed also by applying a bonding agent, for forming the spacer, on the surface of the non-sintered solid electrolytic sheet 160 or non-sintered cover heater sheet 1960. In such alternation, a bonding agent having composition or component identical to that of the bonding agent 5 may be also utilized for the bonding agents for the spacer, or it may be applicable to the support member mentioned hereinbefore with reference to the embodiment of the gas sensor element.

### Embodiment 2

Hereunder, the second embodiment, through experiment, of the manufacturing method of the gas sensor element 1A of the present invention will be described. In this embodiment, a measurement was performed as to the relationship between the viscosity [Pa·s] at the temperature of 20°C. of the metal paste shown in the above embodiment 1 and A/B×100 (%) (ratio the width A of the flat portion 199, 201, 301, 401 to the width B of the conductive layer 190, 20, 30, 40).

That is, by changing the viscosity of the metal paste at the temperature of 20° C. to the viscosity of 120 to 280 [Pa ·s], the screen printing was effected to the surfaces of the non-sintered heater sheet 1950 or non-sintered solid electrolytic sheets 140, 160 and, then, the ration A/B (%) was measured.

As a result of such measurement, in a case where the viscosity of the metal paste at the temperature of 20° C. was 150 to 250 [Pa·s] , the ratio A/B×100 (%) became more than 3%, which revealed the effect of preventing the cracks from being generated. On the other hand, in a case where the viscosity of the metal paste at the temperature of 20° C. was less than 150 [Pa·s], it was found to be impossible to form the conductive layers 190, 20, 30, 40 having desired shapes because of too low viscosity. Furthermore, in a case where the viscosity of the metal paste at the temperature of 20° C. was more than 250 [Pa·s], the crack generation preventing effect could not be effectively achieved because of too small thickness of the widths of the flat portions 199, 201, 301, 401 formed on the conductive layers.

### Embodiment 3

This embodiment, through experiment, represents a method in which the flat portions 199, 201, 301, and 401 were not formed by using a metal paste having low viscosity and were formed by pressurizing the conductive layers 190, 20, 30 and 40 which are formed through the printing process by using the metal paste.

That is, in this embodiment, the conductive layer formation process includes a printing step, a drying step and a flat portion forming step. In the printing step, the metal paste for forming the conductive layer 190 is printed on the surface of the non-sintered heater sheet 1950. Likely, the metal pastes for forming the conductive layers 20, 30, 40 are also printed on the surfaces of the non-sintered solid electrolytic sheets 140, 160.

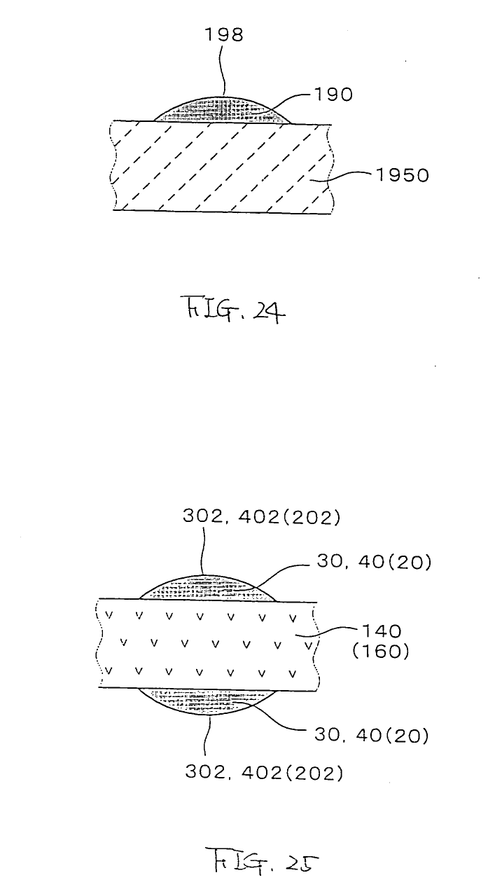

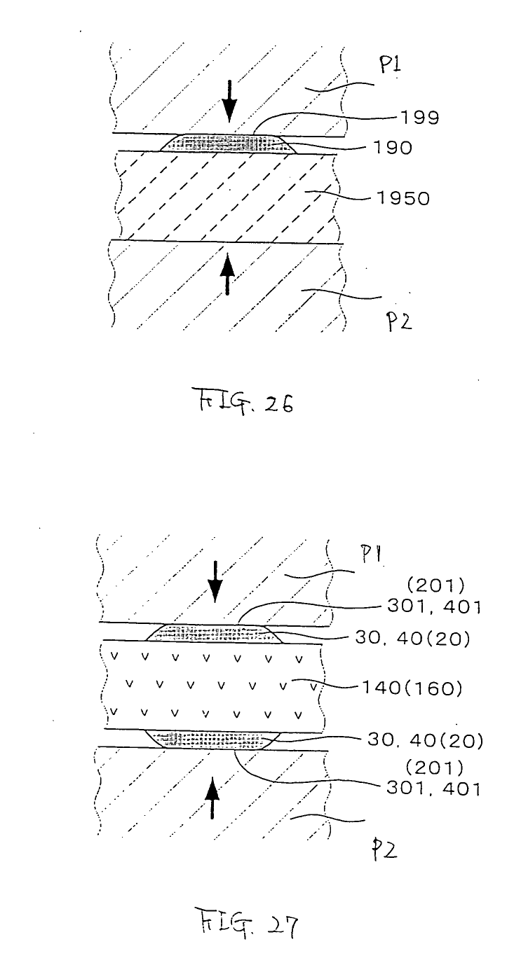

In the drying step, the above respective metal pastes are dried to thereby form the conductive layers 190, 20, 30 and 40. As shown in FIGS. 24 and 25, the thus formed conductive layers 190, 20, 30 and 40 each has a circular or circular-arc sectional shape in its width direction.

Then, in the flat portion forming step, as shown in FIG. 26, the conductive layer 190 is pressurized by snapping the non-sintered heater sheet 1950 between a pair of pressing members P1 and P2 of a press. In this step, the protruded front end portion 198 of the circular-arc shaped conductive layer 190 is pressurized and then crushed to thereby provide the flat end portion 199. This flat portion 199 has a width A of more than 3% with respect to the width B of the conductive layer 190 (A/B×100=3 (%)). In this embodiment, the pressure was applied till the ratio A/B became about 70 (%).

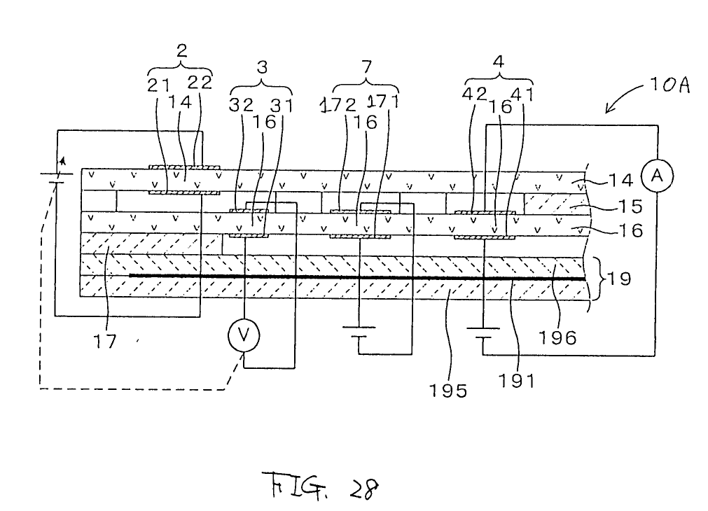

Furthermore, as shown in FIG. 27, in the flat portion forming step, the conductive layers 30, 40 and 20 are pressurized by snapping the non-sintered solid electrolytic sheets 140 and 160 between a pair of pressing members P1 and P2 of a press. In this step, the protruded front end portions 202, 302 and 402 of the circular-arc shaped conductive layers 20, 30 and 40 are pressurized and then crushed to thereby provide the flat end portions 201, 301 and 401, respectively. In this embodiment, the pressure was applied till the ratio A/B became about 80 (%) Thereafter, as like as the first method embodiment, the lamination step and sintering step were performed to thereby manufacture the gas sensor element 1A in which the respective sheets 131, 132, 14, 16, 195 and 196 (after the sintering step) and the spacers 133, 15 and 17 (after the sintering step) were laminated.

In this embodiment, the other steps were substantially the same as or identical to those in the first embodiment and substantially the same advantageous effects could be achieved.

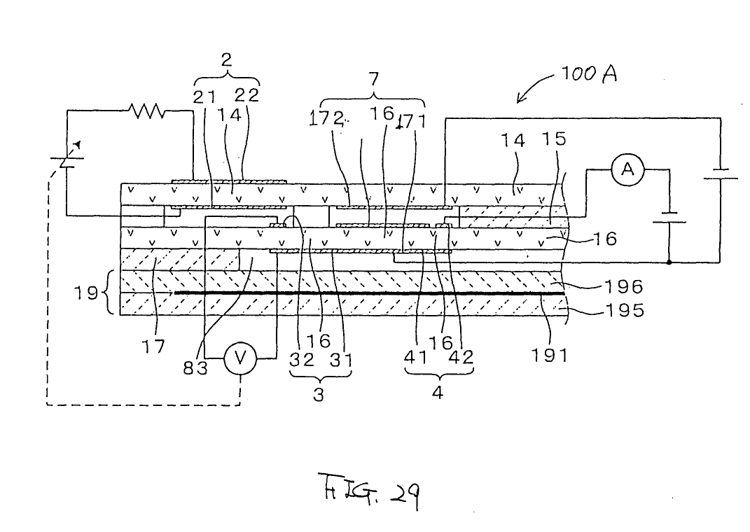

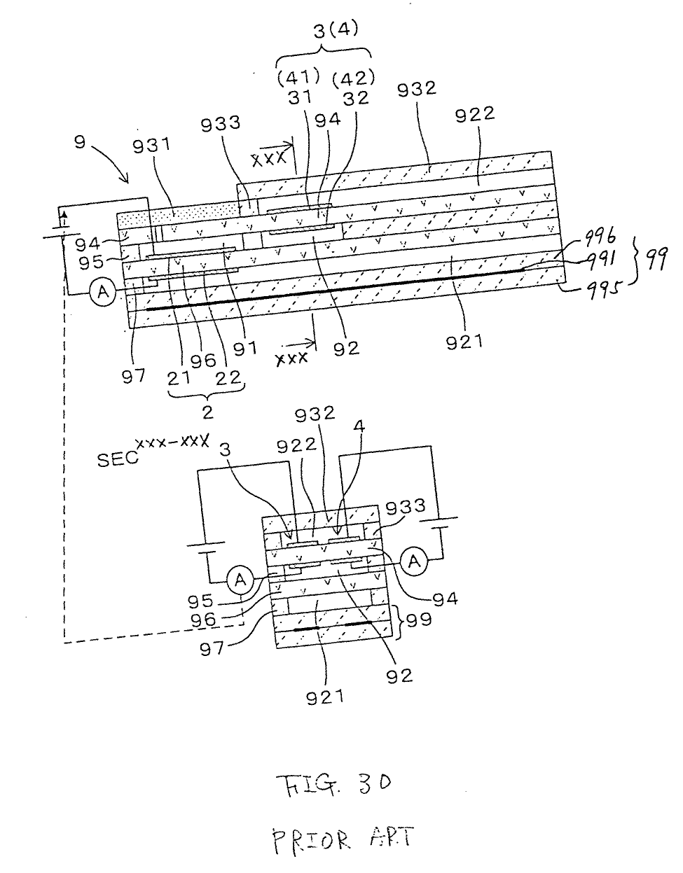

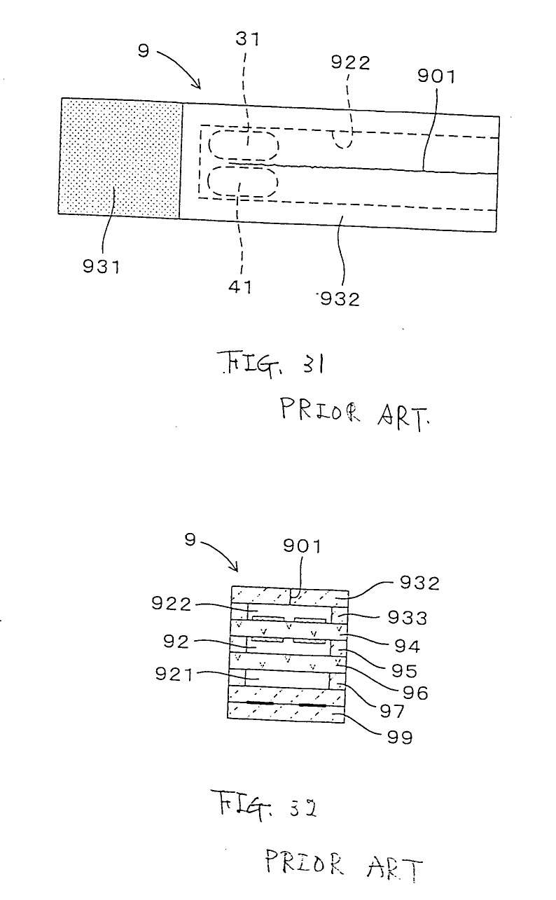

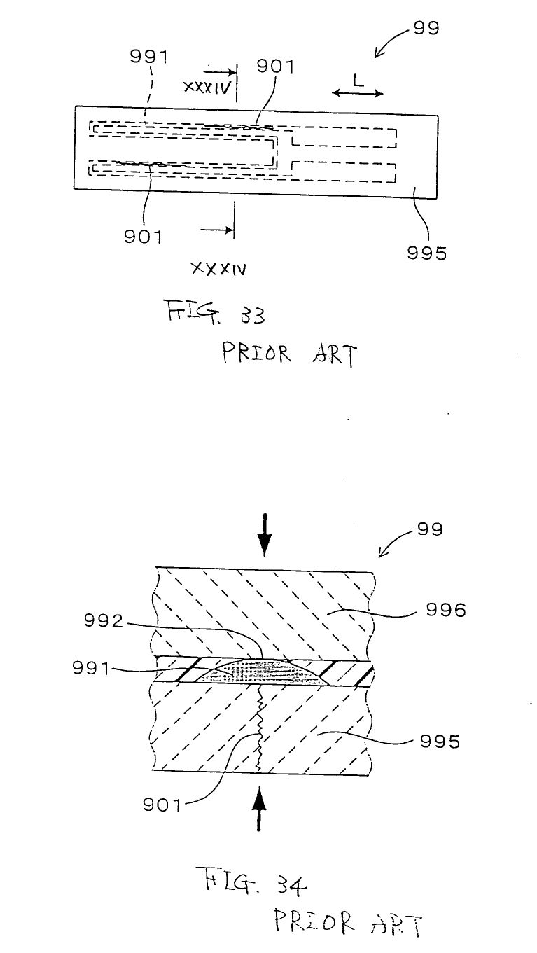

Furthermore, it is to be noted that although the manufacturing methods of the above embodiments of manufacturing the gas sensor element 1A are described specifically described with reference to FIGS. 15 and 16, these methods may be applicable to the gas sensor elements 10A and 100A of FIGS. 28 and 29, which may basically correspond to the gas sensor element 10 and 100 of FIGS. 11 and 13, respectively.

The gas sensor element 10A of FIG. 14 includes the pump cell 2 formed to the solid electrolytic sheet 14, and the monitor cell 3 and the sensor cell 4 are formed to the solid electrolytic sheet 16. A secondary pump cell 7 including a pair of electrodes 171 and 172 is further disposed so as to regulate the oxygen concentration.

The gas sensor element 100A of FIG. 29 includes the pump cell 2 formed to the solid electrolytic sheet 14, and the monitor cell 3 and the sensor cell 4 are formed to the solid electrolytic sheet 16. Secondary pump cells 7, each including a pair of electrodes 171 and 172, are further disposed so as to regulate the oxygen concentration.

It is to be noted that the present invention is not limited to the specifically described embodiments mentioned above and many other changes and modifications or alternations may be made without departing from the scopes of the appended claims.

What is claimed is:

1. A gas sensor element comprising:
a solid electrolytic sheet provided with a pair of electrodes so as to constitute an electrochemical cell;
another sheet disposed so as to oppose to the solid electrolytic sheet so as to define a gas chamber therebetween in which gas contacts the electrodes;
a spacer disposed in the gas chamber between the solid electrolytic sheet and the another opposing sheet; and
a support member disposed in the gas chamber so as to support a pressing force applied in a direction of lamination of the solid electrolytic sheet and the another sheet.

2. The gas sensor element according to claim 1, wherein said gas chamber has a long scale extending along a longitudinal direction thereof and said support member is disposed at a position for supporting substantially a central portion of the gas chamber in a width direction thereof normal to the longitudinal direction thereof.

3. The gas sensor element according to claim 1, wherein said support member has a sectional area taken along a line normal to the longitudinal direction of the gas chamber, said sectional area occupies 5 to 95% of a sectional area of the gas chamber in the longitudinal direction thereof.

4. A gas sensor element comprising:
a shield sheet;
a first solid electrolytic sheet constituting a monitor cell and a sensor cell;
a first spacer disposed between the shield sheet and the first solid electrolytic sheet so as to form a first reference gas chamber;
a second solid electrolytic sheet constituting a pump cell;
a second spacer disposed between the first and second solid electrolytic sheets so as to form a gas measurement chamber;
a heater sheet provided with a heating element;
a third spacer disposed between the second solid electrolytic sheet and the heater sheet so as to form a second reference gas chamber, said shield sheet, said first and second solid electrolytic sheets and said heater sheet being laminated in a predetermined order; and
support members disposed respectively in the first and second reference gas chambers and the gas measurement chamber.

5. A gas sensor element comprising:
a first solid electrolytic sheet constituting a first pump cell;
a second solid electrolytic sheet constituting a second pump cell, a monitor cell and a sensor cell;
a first spacer disposed between the first and second solid electrolytic sheets so as to form a gas measurement chamber;
a heater sheet provided with a heating element;
a second spacer disposed between the second solid electrolytic sheet and the heater sheet so as to form a reference gas chamber, said first and second solid electrolytic sheets and said heater sheet being laminated in a predetermined order; and
support members disposed respectively in the reference gas chamber and the gas measurement chamber.

6. A method of manufacturing a gas sensor element comprising the steps of:
preparing a non-sintered substrate;
forming a conductive layer on a surface of the non-sintered substrate and forming a flat portion on a surface of the conductive layer during the conductive layer forming step so that the flat portion has a width more than 3% of a width of the conductive layer;
laminating a non-sintered lamination sheet on the surface of the conductive layer on the non-sintered substrate so as to provide an intermediate product; and
sintering the thus laminated intermediate product.

7. The method of manufacturing a gas sensor element according to claim 6, wherein said conductive layer comprises a heat generation portion and a lead portion for connecting the heat generation portion to an external element of the gas sensor element, and said substrate comprises a heater sheet provided with a conductive layer.

8. The method of manufacturing a gas sensor element according to claim 6, wherein said conductive layer comprises an electrode and a lead portion for connecting the heat generation portion to an external element of the gas sensor element, and said substrate comprises a solid electrolytic sheet provided with a pair of conductive layers so as to constitute an electrochemical cell.

9. A method of manufacturing a gas sensor element comprising the steps of:
preparing a non-sintered substrate;
printing a metal past on a surface of the non-sintered substrate so as to form a conductive layer thereon, said metal paste having a viscosity of 200±50 [Pa·s] at a temperature of 20° C.;
forming a flat portion on a surface of the conductive layer formed of the metal paste;
laminating a non-sintered lamination sheet on the surface of the conductive layer on the non-sintered substrate so as to provide an intermediate product; and
sintering the thus laminated intermediate product.

10. The method of manufacturing a gas sensor element according to claim 9, wherein said conductive layer comprises a heat generation portion and a lead portion for connecting the heat generation portion to an external element of the gas sensor element, and said substrate comprises a heater sheet provided with a conductive layer.

11. The method of manufacturing a gas sensor element according to claim 9, wherein said conductive-layer comprises an electrode and a lead portion for connecting the heat generation portion to an external element of the gas sensor element, and said substrate comprises a solid electrolytic sheet provided with a pair of conductive layers so as to constitute an electrochemical cell.

12. The method of manufacturing a gas sensor element according to claim 9, wherein said metal paste is composed of at least one kind of noble metal consisting of Au, Pt, Pd and Rh, a resin and a solvent.

13. A method of manufacturing a gas sensor element comprising the steps of:
preparing a non-sintered substrate;
printing a metal paste on a surface of the non-sintered substrate for a conductive layer;
drying the metal paste so as to form the conductive layer;
forming a flat portion by pressurizing the conductive layer so that the flat portion has a width more than 3% of a width of the conductive layer;
laminating a non-sintered lamination sheet on the surface of the conductive layer on the non-sintered substrate so as to provide an intermediate product; and
sintering the thus laminated intermediate product.

14. The method of manufacturing a gas sensor element according to claim 13, wherein said conductive layer comprises a heat generation portion and a lead portion for connecting the heat generation portion to an external element of the gas sensor element, and said substrate comprises a heater sheet provided with a conductive layer.

15. The method of manufacturing a gas sensor element according to claim 13, wherein said conductive layer comprises an electrode and a lead portion for connecting the heat generation portion to an external element of the gas sensor element, and said substrate comprises a solid electrolytic sheet provided with a pair of conductive layers so as to constitute an electrochemical cell.

16. The method of manufacturing a gas sensor element according to claim 13, wherein said metal paste is composed of at least one kind of noble metal consisting of Au, Pt, Pd and Rh, a resin and a solvent.
